(19) United States
(12) Patent Application Publication
(10) Pub. No.: US 2025/0095505 A1
(43) Pub. Date: Mar. 20, 2025

(54) TACTILE INSTRUCTION APPARATUS

(71) Applicants: Sandra Dawn Woodward, St. Pete Beach, FL (US); James Battley Logan, St. Pete Beach, FL (US)

(72) Inventors: Sandra Dawn Woodward, St. Pete Beach, FL (US); James Battley Logan, St. Pete Beach, FL (US)

(21) Appl. No.: 18/949,595

(22) Filed: Nov. 15, 2024

Related U.S. Application Data
(60) Provisional application No. 63/582,890, filed on Sep. 15, 2023.

(51) Int. Cl. G09B 1/08; G09B 13/00

(52) U.S. Cl. CPC G09B 1/08; G09B 13/00

(57) ABSTRACT

The present disclosure discloses a tactile instruction apparatus. The tactile instruction apparatus may be a magnetic letter board including a frame having a top surface and a bottom surface. The frame may include a magnetic material configured to removably mount a magnetic letter tile and a layout of alphabet letters disposed on the top surface. The layout of alphabet letters may be a QWERTY keyboard layout. In use a user can place one or more magnetic letter tiles on one of several portions of the magnetic letter board to form words, or sentences, and learn standard QWERTY organization.

### CROSS-REFERENCE TO RELATED APPLICATIONS

This application claims the benefit of priority of U.S. provisional application No. 63/582,890, filed Sep. 15, 2023, the entire contents of which are herein incorporated by reference.

### BACKGROUND OF THE INVENTION

### Field of the Invention

The present invention relates generally to a tactile instruction apparatus, and more particularly to a tactile instruction apparatus in the form of a magnetic letter board with a QWERTY keyboard alphabet layout.

### Description of the Related Art

Tactile instruction apparatuses are used to provide tactile learning to learners in which the learners need to physically touch an element or item to learn a concept. An example of a tactile instruction apparatus is a magnetic letter board that provides phonemic awareness and improves phonics skills of young learners learning to build words.

Typically, a magnetic letter board includes a layout of letters, most often arranged in alphabetical order, and a learner may removably mount magnetic letters to the magnetic letter board to learn the alphabet and build words. However, real world devices, such as keyboards on computers and mobile phones, use different letter arrangements. Thus, when confronted with real world devices, learners may have difficulties using real-world devices due to the different letter arrangement. Specifically, as a learner uses a conventional magnetic letter board, with letters arranged in alphabetical order, to practice word building skills, the learner becomes familiar with the alphabetical arrangement of the letters through familiarity and repetition. However, when the learner uses a keyboard of a computer or a mobile phone, the learner must search for individual letters on the keyboard, which creates confusion and inconvenience.

Thus, there is a need for a magnetic letter board that enables learners to use real-world devices without any difficulty or confusion. The present invention solves these problems by a tactile instruction apparatus including letters in a format found on real world devices, thereby allowing learners to better use those real-world devices.

### SUMMARY OF THE INVENTION

In accordance with embodiments of the invention, the present invention broadly comprises a tactile instruction apparatus. In some embodiments, the tactile instruction apparatus may be a magnetic letter board. The tactile instruction apparatus may include a frame having a top surface and a bottom surface. The frame may include a magnetic material configured to removably mount a magnetic letter tile and a layout of alphabet letters disposed on the top surface. The layout of alphabet letters may be a QWERTY keyboard layout.

These and other features, aspects, and advantages of the present invention will become better understood with reference to the following description.

### BRIEF DESCRIPTION OF THE DRAWINGS

Illustrative embodiments of the present invention are described herein with reference to the accompanying drawings, in which:

FIG. 1 depicts a perspective view of a magnetic letter board having magnetic tiles affixed thereto in accordance with an embodiment of the present invention;

FIG. 2 depicts a perspective view of a magnetic letter board without magnetic tiles affixed thereto in accordance with an embodiment of the present invention;

FIG. 3 depicts a plurality of magnetic tiles in accordance with an embodiment of the present invention;

FIG. 4 depicts a front perspective view of a magnetic tile in accordance with an embodiment of the present invention;

FIG. 5 depicts a rear perspective view of a magnetic tile in accordance with an embodiment of the present invention; and

FIG. 6 depicts a flow diagram of a method of use of a magnetic letter board in accordance with an embodiment of the present invention.

### DESCRIPTION OF INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

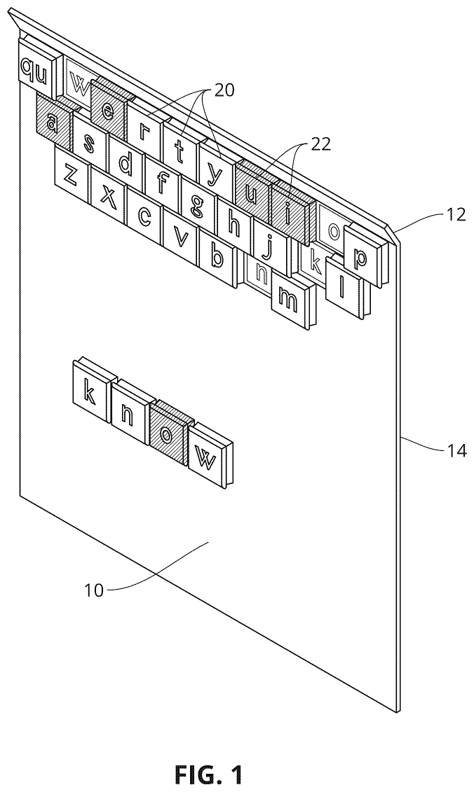

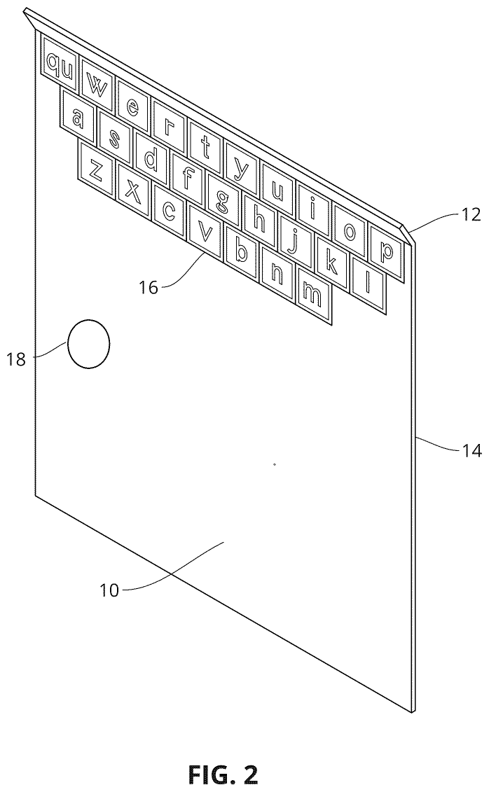

With reference now to the Figures, FIG. 1 depicts a front perspective view of a magnetic letter board 10 with magnetic tiles, such as consonant tiles 20 and vowel tiles 22 removably affixed thereto in accordance with an embodiment of the present invention. FIG. 1 will be described in conjunction with FIG. 2, which depicts a front perspective view of the magnetic letter board 10, without magnetic tiles 20, or 22 affixed thereto. The magnetic letter board 10 may include a frame, having an upper portion 12 and a main body portion 14, wherein the frame, and/or top portion 12 and main body portion 14, may comprise a first magnetic material (e.g., a steel or ferrous sheet) that enables the attachment of magnetic objects on the frame. The frame may be rectangular, or alternatively cuboid, in shape and sized to match the size of a computer tablet, smartphone or other modern keyboard inclusive device, as depicted in FIGS. 1 and 2, but in alternative embodiments the frame may be any shape and size desired (e.g., circular, triangular, cuboid, or otherwise polygonal; the size of a desk or dry-erase board).

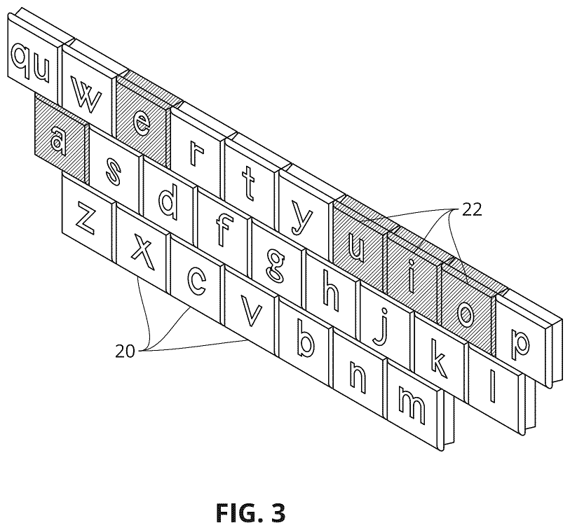

The frame, and/or top portion 12 and main body portion 14, may include a plurality of surfaces, such as top surface and a bottom surface disposed opposite to the top surface. In some embodiments, the frame, and/or top portion 12 and main body portion 14, may further include one or more portions such as a first portion and a second portion on the top surface of the frame, and/or top portion 12 and main body portion 14. In embodiments, a first portion of main body portion 14 may be proximate to an interface with top portion 12 and may include indicia 16 that may be associated with a layout of alphabet letters, on which magnetic tiles (shown as magnetic tiles 20 and/or 22 in FIGS. 1 and 3) may be mounted. The indicia 16 may be markings to indicate locations of individual letters on which a corresponding magnetic tile may be placed. When the indicia 16 include a layout of alphabet letters, the layout of alphabet letters may be in a “QWERTY” keyboard layout (as depicted in FIGS. 1 and 2), so that a learner using the magnetic letter board 10 may memorize the locations of individual letters on the “QWERTY” keyboard layout. Such an arrangement of letters on the magnetic letter board 10 enhances the learner's ability to operate real-world devices that use “QWERTY” keyboard layouts, such as computers or mobile phones.

The first portion of main body portion 14, which includes the indicia 16, may be formed by using any suitable manufacturing process for forming indicia 16 in or on an object. For example, the indicia 16 may be formed by etching, carving, embossing, painting, dyeing, or stamping.

In some embodiments, the layout of alphabets may be color coded, or have other indicia distinguishing consonants from vowels. For example, consonants may be highlighted with a first color, or first emphasis, such as bolding, italicizing, or emphasizing in any manner, and vowels may be highlighted with a second color, or second emphasis, such as bolding, italicizing, or emphasizing in any manner.

The second portion of main body portion 14 may include a predefined area. This predefined area may be used for any number of purposes, including word building using magnetic tiles 20 and/or 22. In certain embodiments, the second portion of main body portion 14 may include an additional marking 18 to indicate a location or a starting point for building words. The additional marking 18 may be a color-coded dot of any size and shape that fits within the predefined area. In the exemplary embodiment depicted in FIG. 2, the additional marking 18 is circular in shape, having a diameter in a range of 0.2-0.8 inches (preferably around 0.5 inches). The additional marking 18 may be located at a left side or center of the main body portion 14 (in the second portion).

In some embodiments, a length of the first portion of main body portion 14 and a length of the second portion of main body portion 14 may be the same. In other embodiments, the length of the first portion may be less (or more) than the length of the second portion.

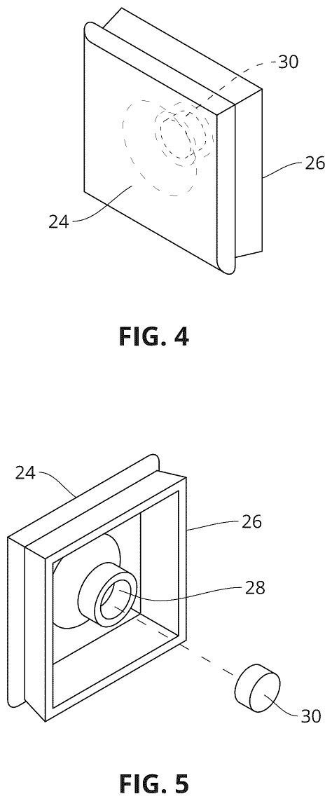

FIGS. 3-5 depict exemplary views of a magnetic tile 20 and 22 in accordance with an embodiment of the present invention. Specifically, FIG. 3 depicts a top perspective view of a plurality of magnetic tiles having alphabetic indicia thereon, including consonant tiles 20 and vowel tiles 22. FIG. 4 depicts a front perspective view of the magnetic tile, and FIG. 5 depicts a rear perspective view of the magnetic tile.

Magnetic tile 20 and/or 22 may have a plurality of components including a face 24, a base 26, a housing 28, and attachment means 30. In embodiments, face 24 may include a plurality of surfaces, such as a top surface and a bottom surface disposed opposite the top surface. In embodiments, the top surface can include indicia, such as markings indicative of alphabet letters. In embodiments, the bottom surface may interface, or may be continuously formed, to base 26 and housing 28. The magnetic tiles 20 and/or 22 may be made of any material durable and safe enough for a learner to handle the magnetic tiles 20 and/or 22. In some embodiments, the magnetic tiles 20 and/or 22 may be made of plastic and may include an attachment means 30 (e.g., a disc magnet, as depicted in FIG. 5) that enables the magnetic tiles 20 and/or 22 to be mounted on the magnetic letter board 10. Advantageously, face 24 may provide a learner indicia to match indicia 16 on main body portion 14, thereby allowing the learner to learn the organization of a “QWERTY” keyboard, while also providing for proper storage of tiles 20 and/or 22.

Base 26 may include a plurality of surfaces and may be shaped as a hollow frustum, although other shapes known in the art are equally contemplated. In embodiments, base 26 may interface with face 24, or may be continuously formed thereto, and may have a hollow portion configured to house housing 30. In embodiments, a top surface of base 26 may interface, or may be continuously molded to a bottom surface of face 24, thereby providing support for face 24, while a bottom surface of base 26 can interface with main body portion 14 of the frame. Advantageously, base 26 allows for stable placement of tiles 20 and/or 22 during use and storage.

Housing 28 may include a plurality of surfaces, and/or geometric shapes, and may be configured to securely house attachment means 30. In embodiments, housing 28 can include at least a bottom portion and a top portion. In embodiments, the bottom portion can be a spherical segment, and/or hemisphere, but is not so limited, and may interface, or be continuously molded, to bottom surface of face 24. Advantageously, the bottom portion allows for proper spacing of housing such that attachment means 30 can be removably affixed to main body portion 14. In embodiments, top portion may interface, or be continuously molded to bottom portion, and may be tubular in shape, but is not so limited. In embodiments, top portion has an inner recessed portion configured to securely house attachment means 30. In embodiments, at least one surface of the top portion can be coplanar with the bottom surface of base 26 such that when tiles 20 and/or 22 are removably affixed to magnetic letter board 10 the at least one surface of the top portion and the bottom surface of base 26 rest flush on magnetic letter board 10.

Attachment means 30 can be securably, or removably, housed in housing 28. In embodiments, attachment means can be shaped as a cylinder, but is not so limited, as attachment means 30 only needs to be shaped such that it may fit within the inner recessed portion of housing 28. In embodiments, attachment means can be a magnet, or ferromagnetic material, such as a disc magnet, but is not so limited. The attachment means 30 may be of any size suitable for a learner to place the magnetic tiles 20 and/or 22 on the magnetic letter board 10. For example, the second magnetic material 304 may have a diameter of about 5 mm and a thickness of about 2 mm.

In some embodiments, the magnetic tiles 20 and/or 22 may be a magnetic letter tile on which a single letter is printed, stamped, etched or otherwise formed on face 24 of the magnetic tiles 20 and/or 22. The magnetic tiles 20 and/or 22 may be removably mounted anywhere on magnetic letter board 10. For example, a learner may mount the magnetic tiles 20 and/or 22 on the first portion of main body portion 14 (e.g., over the indicia 16) or on the second portion of main body portion 14 (e.g., in the word building area). The magnetic tiles 20 and/or 22 may be of any shape such as square-shaped, circular-shaped, etc. In the embodiment depicted in FIGS. 3-5, the magnetic tiles 20 and/or 22 are a combination of a cuboid affixed to a hollow frustum. Further, the magnetic tiles 20 and/or 22 may be of any dimension. In some embodiments, the dimension of the magnetic tiles 20 and/or 22 may be based on the layout of the alphabets on the magnetic letter board 10. For example, each side of the magnetic tiles 20 and/or 22 may be around 1.2 inches long.

In some embodiments, the magnetic tiles 20 and/or 22 may be color-coded, or emphasized utilizing other indicia, such as bolding, italics, underlines, etc. to correspond to the color-coding, or emphasis, of the indicia on the magnetic letter board 10. For example, the magnetic tiles 20 associated with consonants may be highlighted with the first color, or otherwise emphasized, and the magnetic tiles 22 associated with vowels may be highlighted with the second color, or otherwise emphasized. The use of color-coded, or emphasis, magnetic tiles 20 and/or 22 and the indicia enables a learner to visualize abstract spelling concepts and the different roles that letters have.

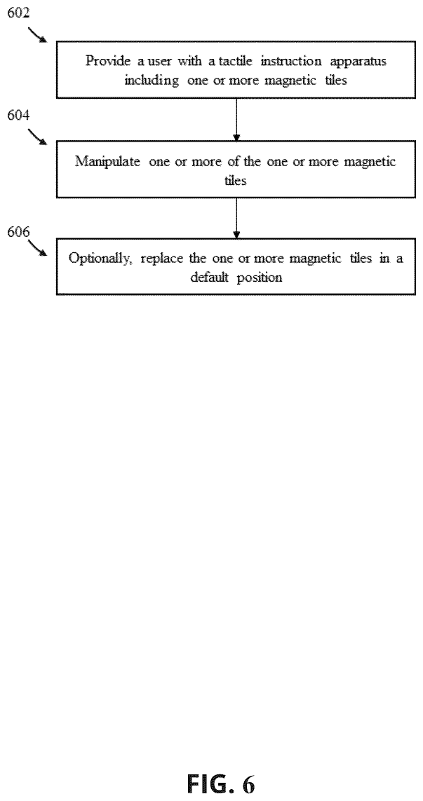

Referring now to FIG. 6, a method 600 of using magnetic letter board 10 is illustrated. Method 600 can be at step 602 when a user is provided with a tactile instruction apparatus, such as magnetic letter board 10. In embodiments, the tactile instruction apparatus, as magnetic letter board 10, can be provided with one or more magnetic tiles, such as tiles 20 and/or 22 affixed thereto. In embodiments, each of the one or more magnetic tiles, such as tiles 20 and/or 22, can be placed over an indicia corresponding to an indicia on the one or more tiles (as illustrated in FIG. 1). Additionally, the one ore more magnetic tiles can be affixed to any portion of magnetic letter board 10, or can be provided to the user not affixed to magnetic letter board 10.

At step 604, the user can manipulate one or more of the one or more magnetic tiles. In embodiments, manipulation can include removing one or more magnetic tiles from the board, placing one or more magnetic tiles on one or more corresponding indicia of magnetic board 10, placing one or more magnetic tiles on a portion of magnetic board 10 indicating a starting point, placing one or more tiles in sequence, etc. In an exemplary embodiment, the one or more magnetic tiles include alphabet indicia, which a user can utilize to form words, or sentences, by placing one or more of the one or more magnetic tiles in sequences.

At step 604, optionally, the user can replace the one or more magnetic tiles in a default position. In embodiments, a default position can be the position they were provided to the user in, such as place over an indicia on magnetic tile board 10 corresponding to an indicia on the one or more magnetic tiles. Additionally, the default position could be any position affixed to, or unaffixed to magnetic tile board 10. Advantageously, method 600 allows a user to learn, through use and repetitive, an organization of indicia, such as alphabets, according to standard organizational techniques, such as appearance of alphabets on device keyboards.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

It should be understood, of course, that the foregoing relates to exemplary embodiments of the invention and that modifications may be made without departing from the spirit and scope of the invention as set forth in the following claims.

The claimed invention is:

1. A tactile instruction apparatus comprising:
a frame comprising a top surface and a bottom surface disposed opposite to the top surface, wherein the frame comprises:
a magnetic material configured to removably mount a magnetic letter tile; and
a layout of alphabets disposed on a first portion of the top surface, wherein the layout of alphabets is a QWERTY keyboard layout of alphabets; and
a plurality of tiles, each of the tiles having an indicia corresponding to one of the layout of alphabets and an attachment means.

2. The tactile instruction apparatus of claim 1, further comprising:
a second portion of the top surface having an indicia thereon indicative of a start position for word formation.

3. The tactile instruction apparatus of claim 1, wherein the attachment means is one of a magnet, or a ferromagnetic material.

4. The tactile instruction apparatus of claim 1, wherein each of the plurality of tiles further comprises:
a face having a first surface and a second surface disposed opposite of the first surface, wherein the indicia is disposed on the first surface;
a hollow frustum base continuously formed to the second surface of the face and configured to support the face;
a housing continuously formed to the second surface of the face and disposed within the hollow frustum base, the housing configured to securely house the attachment means.

5. The tactile instruction apparatus of claim 1, wherein a first portion of the layout of alphabets has a first emphasis and a second portion of the layout of alphabets has a second emphasis.

6. The tactile instruction apparatus of claim 4, wherein the first emphasis is a first color, and the second emphasis is a second color different from the first color.

7. A method of learning, comprising:
providing a tactile instruction apparatus, comprising:
a frame comprising a top surface and a bottom surface disposed opposite to the top surface, wherein the frame comprises:
a magnetic material configured to removably mount a magnetic letter tile; and
a layout of alphabets disposed on a first portion the top surface, wherein the layout of alphabets is a QWERTY keyboard layout of alphabets; and
a plurality of tiles, each of the tiles having an indicia corresponding to one of the layout of alphabets and an attachment means;
placing at least one of the plurality of tiles on one of the first portion of the top surface, or a second portion of the top surface.
